(19) United States
(12) Patent Application Publication
(10) Pub. No.: US 2026/0341166 A1
(43) Pub. Date: Oct. 29, 2026

(54) SYSTEM AND METHOD FOR LEARNING AND TRAINING THROUGH NETWORK SIMULATION, ONLINE GAMING AND MACHINE LEARNING

(71) Applicants: Michael Pierre Joseph, Acton, MA (US); William Joseph Goode, Hopedale, MA (US)

(72) Inventors: Michael Pierre Joseph, Acton, MA (US); William Joseph Goode, Hopedale, MA (US)

(21) Appl. No.: 19/120,480

(22) PCT Filed: Oct. 13, 2023
(86) PCT No.: PCT/US2023/035140

§ 371 Date: Apr. 11, 2025

Related U.S. Application Data
(60) Provisional application No. 63/415,844, filed on Oct. 13, 2022.

(51) Int. Cl. G09B 5/02; A63F 13/795; A63F 13/798; A63F 13/822

(52) U.S. Cl. CPC G09B 5/02; A63F 13/795; A63F 13/798; A63F 13/822

(57) ABSTRACT

An apparatus and method are described herein for providing a robust learning and training regimen through network simulation, online gaming, and machine learning. A network simulation for an online gaming platform can include extensible content and a system for measuring a user's progress based on playing a game to improve and measure the user's aptitude for developing industry skills for a desired career path. The extensible content includes using the structure of the game to improve the user's play and aptitude for developing the industry skills by adding and changing the order of play or sequences based on results of feedback from users' quality of play during the game.

### BACKGROUND

### Field

This disclosure relates to field of online gaming and to an apparatus and method for providing a robust learning and training regimen through network simulation, online gaming, and machine learning.

### Description of the Related Art

Conventional learning methods for training competency are characterized primarily by an “instructor-guided” model. In an instructor-guided model, the instructor lectures students for a set number of days or hours either in-person in a classroom or through online learning. In general, the students passively listen to the content and are expected to absorb and understand the material. Upon completing the course using the instructor-guided model, the student may be tested as to their competency and understanding of the material such as through a certification.

Unfortunately, the testing and certifications fail to evaluate accurately whether the student has both learned the material and can apply the learned material to practical applications. For example, even with a certification obtained for a particular skill, such as network security, any potential employer has no way to evaluate whether the potential employee can apply the skills purportedly understood through the certification in an actual work environment and provide the necessary network security. The certification thus fails to provide meaningful information about the practical skills of the person being certified. It would therefore be desirable to have a system available that not only teaches students the information necessary for a particular skill, like network security, but also provide meaningful teaching and evaluation of a student's practical application of the learned skills.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a flow diagram for a gaming environment to provide training for a user according to an embodiment;

FIG. 2 is a flow chart of a gaming sequence to provide gamified learning for a user to develop expertise according to an embodiment;

FIG. 3 illustrates a leaderboard according to an embodiment;

FIG. 4 is a flow diagram of a gamified learning environment to provide training for a user according to another embodiment;

FIG. 5 is a flow chart of a gaming sequence to provide gamified learning for a user to develop expertise according to another embodiment;

FIG. 6 is a flow diagram of a gamified learning environment to provide training for a user according to yet another embodiment;

FIG. 7 is a flow chart of a gaming sequence to provide gamified learning for a user to develop expertise according to still another embodiment;

FIG. 8 is a block diagram illustrating gaming environment according to an embodiment;

FIG. 9 is a graph displaying correlations between user experience and user expertise according to an embodiment; and

FIG. 10 is a Ven diagram displaying relationships between game play, videos, and certification for the gaming environment according to an embodiment.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In one or more instances, structures and components are shown in simplified form in order to avoid obscuring the concepts of the subject technology.

In the drawings referenced herein, like reference numerals designate identical or corresponding parts throughout the several views or embodiments.

While video game technology was initially simple and mildly immersive, gaming systems and methods have now evolved to be both highly engaging and an excellent framework for measuring aptitude. To improve and measure a user's aptitude, a gaming platform can include extensible content and a system for measuring the user's progress based on playing a game, according to some embodiments. The extensible content includes using the structure of the game to improve play by adding and changing the order of play or sequences based on results of feedback from users playing the game, according to some embodiments.

Base development are the standard mechanics found in video gameplay: quests, battles, challenges, and contests. Utilizing base development including common and recognizable gaming techniques, it is possible to provide a learning environment, according to some embodiments, by engaging through both interest and success to improve a user's aptitude in a particular skillset, such as network security, data analytics, or any other skillset in which a gaming environment can test a player's learned skills. In addition to cyber-security, the application of learning through video game play can be applied to any discipline where there is the potential to simulate the actual environment and provide a user-driven immersive experience. Examples of other applications of learning include, but are not limited to, Law, Finance & Investing, Network Engineering, Software Development, Military Strategy, Biology, and Immunology. For example, a court room or legal case can be simulated using gaming techniques. In the area of finance, investing and financial concepts can be taught through simulation of market scenarios using games and gaming techniques. In respect to network engineering, concepts of how different computer networks function can be taught, and students can be trained in a gaming environment to meet knowledge fundamentals required to pass common network certifications. In the area of software engineering, software development and computer science concepts can be taught through games, competitions, and hackathons. In respect to biology, students interested in sciences such as the fundamentals of biology and sub-disciplines e.g., immunology can be taught through a gaming environment. Similar to cyber-security, immunology can be a game where you defend and attack hostile invaders.

Beyond building measurable competency, the game will also be entertaining and competitive which will create greater engagement. The more engaged in play the more the student will learn and the more measurable their competency and perhaps more important, their desire to learn more. The focus on play, growth and scoring will ultimately allow a player to map their skill to an actual career.

The system, according to some embodiments, includes gaming components that are well understood by the participants and include accomplishments measured by skill points, badges, and levels of achievement. Support for multiple game modes allows for players to learn basic skills in a structured environment (e.g., player versus computer) before testing out more complex team-based skills (e.g., player versus player and team vs. team). In addition, artificial intelligence and machine learning techniques can be used, according to some embodiments, to adapt models of gameplay to enhance learning through measured performance including score outcomes and produced achievements, as well as use results and inputs from users during play to modify the game modes and testing to provide an improved learning environment. In some embodiments, the gaming environment itself can leverage available engines that are publicly available for game development, such as the Unreal™ engine.

According to some embodiments, the components of the system can include the following elements all presented via play. One such component is training. In this component, opportunities can be provided to present new content for the topic to be learned. This new content can be presented through video walk-throughs, games, puzzles, and interactive experiences. The measurable aptitude can include earning play achievements such as badges and in-line game add-ons. These “add-ons” can come from completing training levels and be both game money, confirmation of abilities, and/or a combination of both. Quiz techniques can be achieved through applied learning in a contest, according to some embodiments, rather than in a scored test.

An artificial intelligence engine, in accordance with some embodiments, can incorporate feedback from puzzles and game sequences in the form of time to complete as well as path of play. These elements can serve as input elements to the engine to further improve and/or modify scoring of play, as well as introduce new elements. For example, if a challenge or game sequence on cyber-security is presented and a player completes the task in a high achiever level as determined by the current play data, an achievement can be earned that can be used further in the play of the game. Current play data can include time for completing puzzles or responding to actions in a game sequence, the accuracy and/or success of those responses, comparison to others, the efficiency of the play. In addition to achievement, a player can be provided an opportunity to tackle more difficult exercises or challenges to “level up.” For example, play completed by a student-gamer can be timed. If a time played results in a full quest, the timer may be changed to press future contests. Also, if a complex element is deemed too difficult for the players, the system can create a leveling opportunity in the game. Auto leveling will be a game feature which is common in the gaming world, but novel in career training. Based on a player's accomplishments and using the totality of the other players efforts and scores, the engine will announce the achievement of the next level. The level achievement will use machine learning to determine when an individual has achieved a level of play that marks an increased stage of development.

The second component is battle, according to some embodiments. In this component, contestants (e.g., players, users, students, etc.) can test their learning and skills against computer-generated opponents, such as for limited exercise and practices, as well as test their learning and skills in tactical events against other players. In some embodiments, players are constantly measured for time, technique, success, and knowledge, and all battles are recorded for further learning. For example, after a battle in a process analogous to an “instant replay,” a player can review a completed battle to learn from mistakes, identify areas for improvement, and receive additional instruction. Additional platform mechanisms will use data from past gameplay, decision trees, and machine learning to advise the player on possible moves and counter moves to improve their score and level-up. When the player applies these learnings in future battles, they should see improvement in their gameplay and score across metrics. Over time a player's learning path or graphed data will demonstrate understanding of concepts and knowledge. Measurable metrics can include, but are not limited to, which decisions a player has taken on a decision tree path, a player's time between actions, an amount of damage done on a turn, a weighted average of damage done per game, a player's ability to defend attacks, a player's complexity of attacks used, and a player's points total gained per turn or game.

According to some embodiments, the machine-learning component of the game can capture data on every battle including time and decisions (e.g., actions and responses taken by a player during a puzzle or game sequence). In some embodiments, these inputs to the engine can create different future battle sequences and achievements. For example, if a player is able to win a battle within a high achievement time period, that player will be awarded a badge and a chance to compete at a higher skill level.

Another component of the system can be a quest, according to some embodiments. Learning from quests can include, for example, extended experiential learning through an engaged series of events that require skill and extended practice and measurement. An artificial intelligence engine, according to some embodiments, can be a component of quest learning as the path presented to the player on the quest can be adaptive based on previous experiences and information on play of the players themselves as well as based on learning data from other players. In some embodiments, the artificial intelligence engine can be loaded with material that can be automatically selected based on the quality of play.

For example, a security challenge quest can be presented with stages of play that model real world cyber-security challenges. If a player is unable to complete a challenge, this failure to complete can be recorded. If other players are similarly unable to complete the same challenge, the difficulty level of the challenge can be moved to a higher level of play. Once the challenge is achieved, the challenge itself can be “leveled,” thereby the game can establish difficulty through play in some embodiments.

With respect to scoring, a task or a quest within the game can require application of the learned material in a contest, according to some embodiments. Based on the success of action within the game, the player can gain achievements that are usable in furtherance of play. This approach creates an interactive learning that is both engaged and uses a building block style approach. In contrast to traditional learning, where the student is required to memorize material and recall answers, a gaming style of learning according to the embodiments disclosed herein can be immersive and interactive, which is well proven to be far more efficient in drawing a true correlation between student and aptitude.

Another aspect of the system is tracking progress of each player through a variety of scoring elements. One scoring element is implemented through leveling, according to some embodiments. A level is a gaming equivalent of ability and is accomplished by outcome through measured achievement over time and based on results from battles and quests. According to some embodiments, an algorithmic approach to creating levels can use the algorithmic approach K nearest neighbor or KNN. In this regression model, when a player completes a series of tasks within a certain threshold of time (e.g., x minutes) with a certain threshold of success (e.g., y success level), the combined position can be assigned a level of achievement based on this model. In this way, player standing can be constantly re-baselined as additional players join. While players do not lose a level once achieved, the quality can decline.

Another scoring element are badges and achievements, according to some embodiments. Specific skills can be achieved by award of badges and achievements. The game system can allow a learning tool to be built such that, when measurable aptitude of the skill is achieved, the player can receive a badge of success. These badges can be for small or large accomplishments and give the player a sense of continuous learning and growth. A badge can represent a specific accomplishment whereas achievements can be accumulated points against goals. An example of a badge can be a low-level phishing badge, which is achieved when a player avoids a phishing cyber-attack within play. If completed, this badge can be visibly added to the badge list on a player card and allow for future use. An example of an achievement can be a successful compromise of a system within a level. If the player can compromise and prove they have successfully landed on an enemy system, this achievement will be recognized, the player will be awarded points, and virtual money, “coins”, can be added to a bank on the player card.

The system can also be configured to provide a ranking of all players and present the ranking both in local and global settings, according to some embodiments. A ranking can be a comparison score against other players and can be localized to groups, regions, and arbitrary organizations. A global ranking for the entire game community allows for measurable progress.

The artificial intelligence engine can continuously re-rank players and progress to build a more competitive set of games with players playing other players in a challenging environment that promotes learning. If a quest or battle sequence is completed within a sequence of steps or time, that information can feed the engine to change play according to some embodiments. The play itself can be continuously measured, and players can be ranked by play details. In some embodiments, the artificial intelligence engine can leverage its learning data from the users' play to adapt and update the play sequences in order to improve measurements. The quality of decision making through the game can be measured using, according to some embodiments, the Decision Tree algorithmic model including criteria for evaluating the quality and accuracy of decision making. The Decision Tree algorithmic model can rank player performance in gaming by the decisions the player makes compared to an optimal path. For example, given a limited amount of virtual currency and time, the player must make a choice between what types of infrastructure to build their defensive posture. For instance, the player may choose to invest in a next-gen firewall to prevent external threats through the network, or the player may choose to invest in e-mail protection to prevent phishing threats. Depending on an outcome of the play, the players choices of investment can be scored and/or ranked against a standard of play for a quest or a battle among other players.

The ranking system and corresponding display of a leaderboard can drive player behavior. Public achievement with an ability to constantly re-play previous game sequences can drive learning and impact development in a far more accelerated manner. As a result, the leaderboard can have a number of useful elements for player engagement.

According to some embodiments, the system can include group ranking, which allows for groups to form both by player desire and by system creation. Group rankings allow functional teams to compete or friends to join in a pod. To provide the social elements of team learning, the system can allow for groups to be built by the player. In addition to player-created teams, the overall public ranking can use the machine learning based scoring system to rank players and continuously create levels according to some embodiments. The leaderboard can be built such that players do not regress to a lower level but can be scored within the level. As a result, as the total count of players increases over time, the ranking of a player within the level can fall.

Another component to the system includes virtual money, in accordance with some embodiments. Players can earn coins that allow for both exchange of currency for learning tools and creating limitations on element ownership. Coins can also be a method to allow for commercial opportunity including adding paid content to the system for material only available through actual purchase, in some embodiments. Coins can be visual currency within the game and represents a common approach in video games to enable a player to have a degree of wealth to procure items of need within the game. Examples can include the accumulation of coins via interactive play to purchase additional equipment within the game. Coins can also be made available to use to pay for services provided for more traditional testing by commercial bodies such as certification for computer skills like Microsoft™ certification. The game can provide exchange of coins for true payment and third-party companies can be allowed to advertise and accept coins as payment. A connection to traditional industry certification bodies can enable a player to use an achieved certificate outside of the game as measurable aptitude and a higher level of game play.

Virtual money can also provide an opportunity for a non-profit element of the game to be built and delivered, according to some embodiments. For example, providing sponsored virtual money can stimulate low-income learners and the discovery of players with passion and aptitude without regard for economic standing opportunity for accessing costly third-party training. Some considerations for delivering solutions for charity within the game include allowing for sponsorship by commercial entities where lower income learners can achieve virtual money and apply for funding to obtain certification. This approach not only helps the industry find and develop players but can also increase access and interaction for the commercial organization seeking additional certified professionals.

In some embodiments, players can also purchase and earn virtual items that can be used for a variety of purposes both affecting gameplay and those with aesthetic benefits only. These virtual enhancements and upgrades can be sold through a virtual store or traded with other players and can enhance characters, provide collectibles, and unlock types of game play. Virtual money can be used to purchase these items.

With these components in place, the gaming system according to the embodiments described herein, can create a highly extensible and experience-based infrastructure that can be applied to many industries and requirements. The game play structure of learning has proven to be highly effective at engagement as measured by the millions of global gaming consumers but has never been built to develop practical industry skills that one could use in their career. This alternative learning method, according to the embodiments disclosed herein, can allow for engagement for anyone able to access the Internet, thereby improving the opportunity for both employee and employers.

A benefit of such a gaming system is the ability for players to learn real skills during play. Traditional learning provides limited immediate feedback. But in gamified learning, according to the embodiments disclosed herein, the feedback is both immediate and adaptive. With the creation of a game driven learning approach, aptitude measurement can be continuously tracked and adjusted based on the population of players according to some embodiments. The injection of random events, according to some embodiments, can also create non-linear play creating engagement and a requirement for creative thinking.

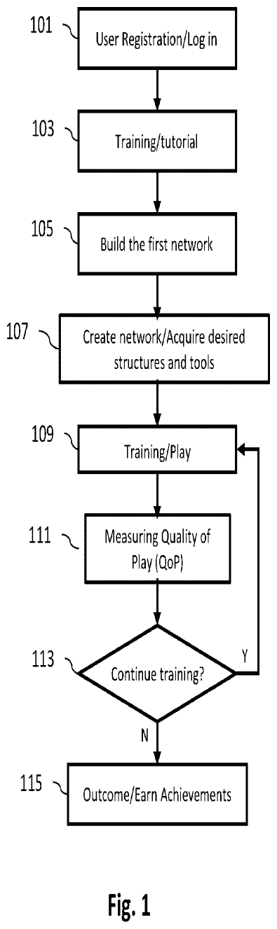

FIG. 1 is a flow diagram for a gaming environment 100 to provide training for a user, according to an embodiment. As shown in FIG. 1, each user can register and be assigned a unique name or identifier (step 101). Players can opt-in to share information about themselves and their gameplay record with third parties. Sharing information publicly and/or with third parties allows for the player to take advantage of external opportunities to be sponsored, participate in e-sports competitions, and take advantage of third-party training in related fields outside of the game. In addition, a public/private feature can be added for interfacing with career opportunity providers. For example, if a game player gaining experience and attaining levels of achievement decides to make their profile publicly available to commercial subscribers, the system can create connectivity with companies and recruiting bodies to enable solicitation of players, in accordance with some embodiments. Content can also be made available via service partnerships to allow learning development of training for specific industry certification programs. For example, a computer training certification can make available content curated into gaming and utilize the platform for a rich learning experience.

Initial engagement with a user can also involve requesting user information to set up an account. This information can include a screen name that is verified as unique. The gaming environment can be configured to offer or suggest available unique screen names and/or configured to confirm a screen name provided by the user is unique. For improved security, a password and multi-factor authentication (MFA) token may be required in combination with the player screen name for accessing the gaming environment. The account setup can also allow a user to mark personal information as public or private including content and address information as well as the game entry point. The user can change the privacy settings according to rules and regulations of the End User License Agreement (EULA).

After registration, a user can start training (step 103). In an initial level of play for a new user, a training level or a tutorial can be started that includes walk-throughs of learning for the game itself and an information training experience, according to some embodiments. For example, for computer network training, a walk-through can include explaining the basic elements of a computer network and how they work. Example play can include demonstrations of learning such as explaining how to build and defend a network including all of the available structures and tools available for such building and defending. A basic understanding of the scoring elements can be provided, although scoring elements can also be learned through play. Once training for a particular level has been completed, a reward can be achieved, and a quick interactive game challenging knowledge can be presented as a mini game within the game in some embodiments.

With training completed, play begins for that level of training (step 105), according to some embodiments. One example of play is a gaming sequence having a series of actions or events. In some embodiments, an initial stage of play includes building the first network. In some embodiments, the system builds the first network in preparation for the user to attack and/or defend. In some embodiments, the user builds the first network in preparation for the user to defend from attacks. The actions or events in the gaming sequence can be a predetermined series of actions. In addition, the gaming sequence can be augmented by one or more random actions or random events that are added to or replacements of the predetermined series of actions or events. As discussed above and further explained herein, the gaming sequence can also be changed by a machine learning engine, such as an artificial intelligence engine, based responses to actions or events by one or more users over time and all other data relevant to the gaming sequence in accordance with some embodiments. As a use of the platform, Cyber Security training and its associated learning model are used throughout this description as an example of the gaming environment described herein, according to some embodiments. It should nevertheless be understood that the gaming environment can be applied to a variety of different trainings and certifications including, for example, Network Engineering—Cisco CCNP, CCIE, VMware certification, CompTIA. Data Engineering—Google Cloud, Microsoft Azure Certification, AWS Cloud Certifications.

In a first level of cyber-security play, for example, the user responds to the action or event provided by the gaming sequence (step 107) to attack or defend the first network, in accordance to some embodiments. To provide a response, the user can be provided with some initial virtual money and choices of technology structures and tools to use in play. The player can spend the virtual money to acquire the desired structures and tools to build their defenses for their network when in defense mode or to acquire the desired structures and tools to attack a network when in attack mode. In some embodiments, card play may be used to create a network and to add cards to meet a basic network build. The play can therefore include both attack and defend elements. By successfully defending (defense mode) or breaching defenses (attack mode), players gain experience points as well as opportunities for additional virtual money. Failure does not result in lost experience but can potentially result in lost money.

Each level of play can be configured to different competitive levels, such as moderately difficult, to ensure engagement of passionate learners, while avoiding being overly complicated to avoid dissuading repeated attempts by users. Lower and introductory levels can be configured to be simpler to engage new users and increase the likelihood of early success. During play, badges can be presented to users based on the player successfully achieving any of a variety of accomplishments, such as multiple successful network defenses and attacks. The game play provides a great deal of secondary learning because participants are engaged, enjoy the battles, and gain success, all while learning is being measured.

For each response by a user, a quality of the response or quality of play (QoP) is measured (step 109) according to some embodiments. This measurement is part of an overall tracking performed in the gaming environment that collects all data, responses, timing, and other relevant information input to the gaming environment by the users. During training or play according to some embodiments, the system can simulate attacks and defends with random event cards for the player to respond to. In particular, all players have elements of play tracked within the system. Time to complete tasks, ability to solve situational challenges, and general content knowledge, for example, can be stored in the system. In addition, performance-based measurements, such as player versus player and player versus computer, allow for relative scoring of aptitude including aptitude relative to other players from battle sequences. Since aptitude attained in battles can be relative, it can help develop a competitive opportunity for growth.

To measure the quality of the response or the quality of play (QoP), the system can evaluate the response against one or more criteria for responding to the particular event or action of the gaming sequence. Withing certain gaming contexts it is possible for each particular event or action, to have an optimal response, one or more less optimal responses, and one or more poor or ineffective responses. This is the case in training scenarios or gameplay with a fixed number of permutations and constraints on the game. User responses will typically result in either the reduction in an opponent's capability by creating damage or an improvement in defense posture. Game play often is measured by a sequence of events leading to a result or in the case of a contest there could be a more traditional question and answer component. In all cases the quality of the response based on the sequence of possible outcomes and the actual result of play will be evaluated and points, badges or levels awarded. According to some embodiments, the quality of the response in the game is determined by the system. In some embodiments, an artificial intelligence (AI) engine provides an adaptive model to continuously update the optimal response. For example, as a modeled real-world scenario is improved by a new event or a new response type, the game will have additive components changing the modeled real-world scenario for future play. For example, the AI engine may update the optimal response by determining a best overall time in play of all players for a given quest and replace the best overall time in play of all players when a player's current time in play is determined to beat the current best overall time in play.

As a user proceeds through a gaming sequence for training and/or play, a random action or event can be inserted into the gaming sequence to simulate attacks and defends. Random events or actions can be a useful component of play and ensure that the game itself is non-linear. The random events can be, for example, pre-defined system generated attacks that can occur at any time and impact the players performance. For example, after a particular cyber-attack occurs during play, the player can be compromised or have a reduced defense depending on the current defense level of the player. The random event or action, like this type of attack, can be arbitrarily selected during simulation to occur at an unpredictable time in the game and built using a random number generator or random event cards. Alternatively, the random event or action can be triggered based on a user's response or responses to prior events or actions. For example, if the user shows repeated high-quality responses to actions in a predetermined sequence of actions in a gaming sequence and/or provides responses in short periods of time, the system can be configured to insert a random event or action to ensure the user faces and can handle unpredictable events or actions that may occur during a gaming sequence. According to some embodiments, a high-quality response and/or a short period of time may be a measured quality of response or measured period of time that is within a threshold of an optimal response (e.g., within the top 10 responses, within a certain pre-determined time interval, within a pre-determined number of steps, or the like) to events or actions. The time for a player to complete can be measured and the quality of the response codified. Other examples of measurable qualities of play include but are not limited to time for a player to finish a sequence of moves resulting in a successful attack or defense, a number of moves taken to complete a challenge, a player's persistence, or tenacity to continue play and learn despite unsuccessful attempts and/or setbacks. These qualities of play may be measured against other players' qualities to determine skill level rankings and/or levels of game play. As such, the game may continuously re-balance levels of game play and players' skill levels.

These random events can be designed to create stressful, but exciting play challenges while also increasing aptitude as failure is a positive motivator for growth in the game. The game can also manage data on outcomes with an understanding of the likelihood of a player having a ready defense based on their skill level and time playing the game. If, for example, a sophisticated attack is successfully handled by a low-level player, that player can also be given an appropriate accomplishment such as a badge or even an increased level.

If a random event or action is inserted, the user provides a response in the same manner as any other event or action in the gaming sequence, and the quality of that response is also measured in the same manner (step 109). The process of providing an event or action to the user, having the user provide a response to that event or action, measuring the quality of the response, and possibly inserting a random event or action to be responded to by a user and measured for its quality continues until the completion of the gaming sequence.

Upon the completion of the gaming sequence, the system generates a score for the user based on the quality of the user responses (step 111). For example, depending on the number of responses in the gaming sequence, the system can be configured to provide a total score where each response provides the same maximum score as all other responses. Alternatively, a maximum score for each response can be different than other responses, such as depending on the difficulty of the response to the applicable action or event, e.g., a higher maximum score may be given for a response having a greater difficulty. In addition, the system can include artificial intelligence and machine learning techniques that adjust scoring continuously based on the collective responses of all users across the system to the same gaming sequence.

According to some embodiments, a decision is made to continue training (step 113). In some embodiments, this decision to continue training may be made by the player (e.g., pausing or ending a training session). In some embodiments, the system may offer the player a decision to continue training (e.g., once a player has reached a certain time in play, once a player has leveled to a satisfactory level to begin competition play, or the like). As the player achieves a new level, this would result in a reward for the player, but will not necessarily complete all training. The system may offer further components based on success and timing achieved to enhance the player's experience and knowledge. As a new technology, technique or reaction is developed it can be introduced as a learning adaptation within the game. New technologies may be introduced through system updates and new techniques and reactions may be introduced through the system determining optimal responses from game play of other players in near real-time. As the game is continuously updated with real-world events, new technologies, auto-leveling, and the like, the gaming opportunities may be endless. As such, players may choose to continue to play and learn as much as they desire.

The outcome or a score is generated for the player based on their performance measured during training or play (step 115), in accordance with some embodiments. The generated score is then compared to a level threshold. If greater than the level threshold, then it is determined that the user has achieved proficiency in that level. One component of the gaming environment for any particular skill are levels. Levels are bands of knowledge and achievement assigned to players based on their accomplishments and battles during play. As users achieve increasing levels of knowledge that are evinced by their scoring during gaming sequences, the user can rise to higher and more complex levels.

Play, whether between a user and a computer or between users, can be both intra level and inter level. This mixture of play creates an opportunity for players to compete against those of similar aptitude as well as to try to move up by beating a player of higher-level achievement. A computer player can also be available for play against a simulated student allowing for both practice and skills measurement as well as to complete a team for team events, thereby allowing for a more complicated event within the game. All of these techniques provide a far more “real world” approach to training as there are often times where a solution requires a team versus an individual.

The gaming environment tracks all activity of users and solicits feedback. Feedback can come in the form of decision making and outcome analysis as well as a grading of approach by users. The immersive nature of battle-based play allows for injection of unexpected or random events and an ability to measure how players handle non-linear pathways. Decisions made can also change the path of play, which ensures that learning is achieved, even while playing the game repetitively. During play, pop-ups can be displayed to users to remind them of game strategy as well as other opportunities for play. Events can be developed that use the community of gamers to create larger challenges with higher levels of competition.

Throughout play, users can have elements assigned to their character that allow them an understanding of their current level of skill, collected attributes and currency, and an active scoreboard (e.g., leaderboard) showing where they stand against others. An active scoreboard based on game play outcomes that continuously measures a user's play against others shows a user's progress and potential areas in need of improvement.

Through the tracking, the gaming environment can maintain highly discrete information in a database that allows the game to provide to the user information on times to complete tasks, comparison charts, and an opportunity to replay a sequence to learn how the decisions impacted the outcome. Such a comparison to improve understanding is analogous to film study in sports where athletes use the game experience to analyze and improve. Any completed gaming sequence can facilitate a very similar experience by allowing replay of the captured play.

The gaming environment is thus able provide teachings of various skills, like cyber-security, by using natural gaming elements of battles, team competitions, and mini-games/contests to teach. As these elements are learned, players are tested via challenges and the opportunity to re-learn by re-play. The real-world nature of immediate application of skills against both computer player simulations and other players develop aptitude at an increased pace and determine both desire and ability. The artificial intelligence and machine learning components of the system drive both arbitrary play as well as measured outcomes. These data elements can be captured in the system to allow the system to further measure achievement and adapt the constructed elements of play to be delivered at different levels.

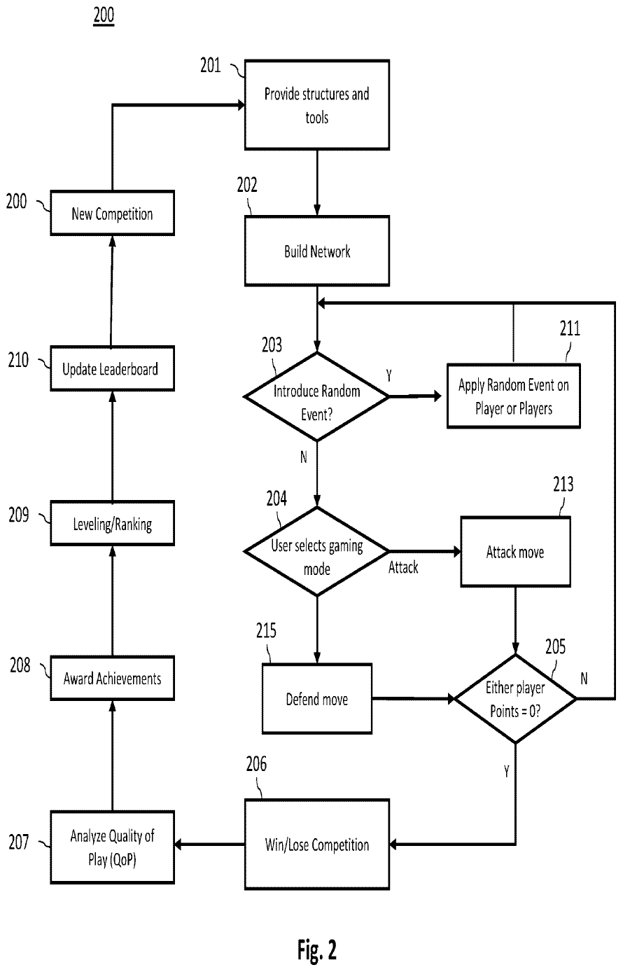

FIG. 2 is a flow chart of a competition style gaming sequence 200 according to an embodiment. In the flow chart of FIG. 2, the competition style gaming sequence 200 relates to network security according to an embodiment. As shown in FIG. 2, a user is provided with a set of structures and tools for building a secure network (step 201). In some embodiments, the user may be given an initial cache of virtual money for use in building the secure network. Building the secure network may include enhancing, scaling, and/or equipping the network.

At step 202, the user is tasked with building the secure network using the structures, tools, and/or initial cache of virtual money provided in step 201. The user can use the initial cache of virtual money as well as learning to build out a network with security elements and infrastructure components. The user can also see the capabilities and limitations of each element chosen as selected. According to some embodiments, the competition style gaming sequence 200 may be a competition between players (e.g., player vs. player). After building the secure network (step 202), the game begins with players taking turns building out (e.g., enhancing, scaling, and/or equipping) their networks.

At step 203, the game can determine whether to introduce a random event into each turn of play that impacts one or both players. The introduction of a random event is intended to simulate real-world external factors that impact information technology systems and cyber-security. If a random event is introduced (step 211) some impact is rendered on gameplay and the turn proceeds. Such random events may serve as assessments of the integrity of the players' secure networks under a real-world external factor.

The user can select a gaming mode (step 204) according to some embodiments. The gaming mode provides the user with a learning experience about the selected elements that enable the user to develop a better understanding of how those selections impact the security of the network. The selected gaming mode can be reasonably simple, while immediately measuring time to complete and choices made by the user. In some embodiments, the gaming mode may be selected using cards to attack or defend. For example, the gaming mode can be a simulation of a Distributed Denial of Service (DDOS) attack. The gaming mode allows the user to “guess” what structures and tools might help in defense. Feedback based on the outcomes can be provided, and the time of engagement and the actions of the user can also be captured.

In addition to somewhat simpler gaming modes, a user can initiate a more sophisticated gaming mode akin to a battle. In some embodiments, the battle can be one-on-one battle (e.g., player vs. player) either with another user or a computer simulated player. The play can allow attack and defend for both users using card selections. Each card can drive success or failure of an attack or defense. If at step 204, a user selects an attack move to be performed, the system simulates the selected attack moves at step 213. If at step 204, a user selects a defend move to be performed, the system simulates the selected defend move at step 215.

Outcomes of the selected attacks and/or defends create points and/or opportunities and the game checks to see if either player's points have been reduced to zero (step 205), according to some embodiments. If the players' points are >zero, the next round of the game proceeds and the systems keeps looping with players taking turns until one player's points have been reduced to zero and the other player has won (206). Decision making can be stored in the machine learning of the system to continuously analyze contestants' quality of play (step 207), in accordance with some embodiments. As the battle completes and a winner and/or loser of a competition is identified (step 206), the data captured can be presented to both users. The opportunity for achievement badges as well as data on play quality, time, and level against system stored information can be provided according to some embodiments.

After a battle, in accordance with some embodiments, a leveling and/or ranking of contestants (step 209) may be performed and a leaderboard may be constructed (step 210) based on the new leveling and/or ranking of contestants can be presented to the user. This leaderboard can have elements of the public standing of the user overall in the entirety of the game universe as well as any chosen or established groups. Options can be presented to the user for paths to learning success including trainings available through the game and third-party learning, additional battles at level, opportunities for mini-games and sequences of learning, growth, and reading on how to improve through play. In some embodiments, the players may decide to participate in a new battle or re-battle (step 200) or the competition may end.

In contrast to the traditional form of learning, the focus of learning in the gaming environment is to make it both fun and outcome based while taking advantage of technical improvements provided by the gaming environment including non-linear play (e.g., random events or actions), artificial intelligence and machine learning to collect data from all users of the system to improve and modify gaming sequences, continuous measurement of user activity to judge proficiency, and active comparison of users against each other to promote competition.

More specifically, the use of an artificial intelligence engine enables the gaming environment and gaming sequences to be more evolutionary and enable adaptive pathing. For example, by tracking and gathering information about performance among users of the gaming environment, the artificial intelligence engine feeds back into the gaming environment through changes to gaming sequences that improve learning going forward. The gaming environment also makes learning entertaining and non-linear. Whereas so much of learning in a traditional environment is linear, in some embodiments, the artificial intelligence engine provides gaming sequences with unpredictable pathways such that a user has the ability to make decisions based on what event or actions is thrown at them during a gaming sequence. By interjecting unexpected events or actions, the user is not learning sequentially. Instead, the artificial intelligence engine provides non-linearity by knowing what has been done previously and adding new actions, events, or sequences that have not been done previously.

A goal of the gaming environment is to use multi-channel approaches to learning. Leaning on some traditional tools in combination with competition, an ever-changing leaderboard, and measurements can drive behavior, desire to play, and aptitude. Aptitude and proficiency can be rewarded measurably in the forms of badges, achievements, and rankings. A user card (e.g., leaderboard) can be maintained allowing the user to see his or her current standing among all users or users within a particular group.

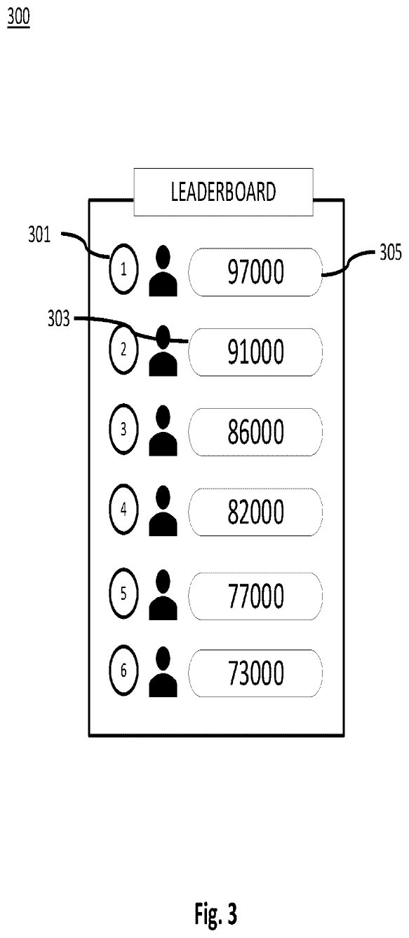

FIG. 3 illustrates a leaderboard 300 according to some embodiments. The leaderboard 300 displays a rank 301, a player icon 303 or identifier (e.g., username), and a player score 305, in accordance with some embodiments.

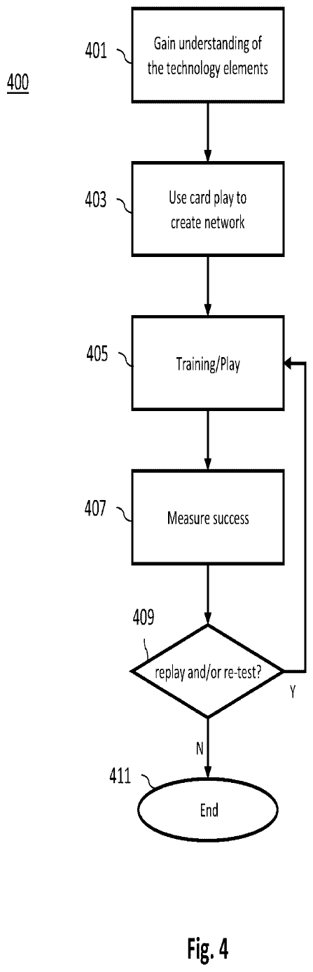

FIG. 4 is a flow diagram of a gamified learning environment 400 to provide training for a user according to another embodiment. The gamified learning environment 400 comprises a tutorial for gaining understanding of the technology elements (step 401), user network build, for example, using card play to create a network (step 403), active game play to train the user and develop user skills (step 405), actively measuring success (step 407); determination to replay and/or re-test the user on the developed skills (step 409); and completion of training (step 411). In some embodiments, in a case where it is determined to replay and/or re-test the user, the gamified learning environment 400 uses the measured success 407 of the user to identify training exercises and active game play that help a user to develop specific skills for player advancement, leveling, and/or industry certification.

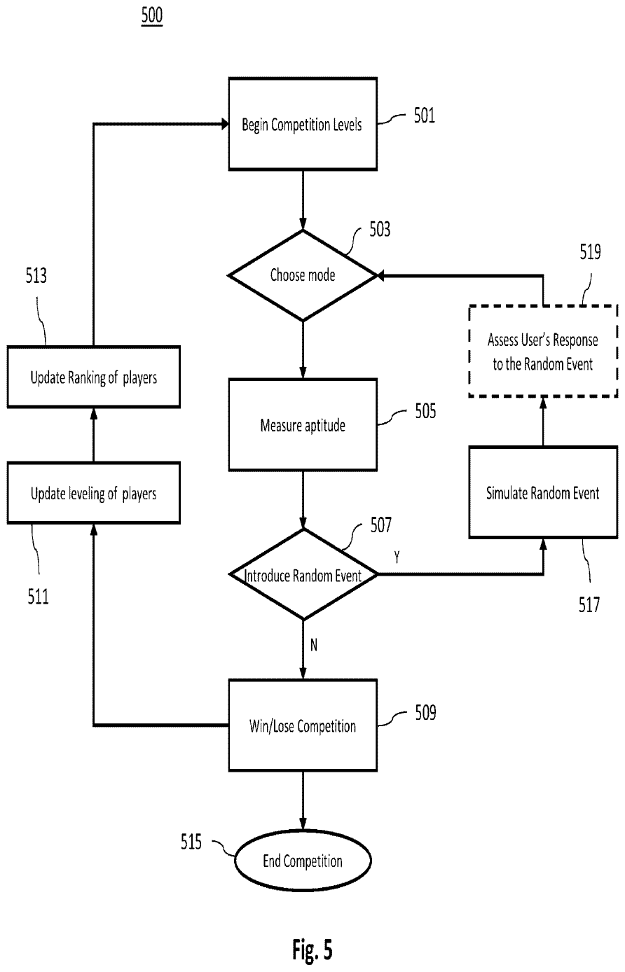

FIG. 5 is a flow chart of a gaming sequence 500 to provide gamified learning for a user to develop expertise according to another embodiment. The gaming sequence 500 comprises: an initial step to begin a level-based competition (step 501) for a selected industry skill set. Level-based competition may include construction or selection of basic elements used in the selected industry (e.g., network security, telecommunications, programming, financial markets, real estate, law practices, engineering, or the like). For example, in network security, telecommunications, and/or programming, a user may be required to construct a data or communications network or develop a program used in controlling such networks selected from groups of industry viable hardware and software. For example, in banking, financial markets, and/or real estate, a user may be required to select a group of assets using an initial cache of virtual money. As another example, in law practices, a user may be given a legal scenario and build a case in defending a client. In engineering, a user may be tasked with designing a circuit, a building, a vehicle, or the like.

At step 503, the user chooses a mode of play. The modes of play that the user can choose from depend on the industry selected. For example, in network security, telecommunications, programming, and/or legal industries, the mode of play may include a choice between an attack/defend based mode. In financial markets and/or real estate industries, the mode of play may include a choice between buy/sell based modes. In engineering industries, the mode of play may include a choice between design/construction-based modes.

At step 505, this step includes measuring a user's aptitude (step 505) for developed skills. The user's aptitude may be measured based on criteria and/or standards used within the selected industry (e.g., elements and/or materials selected, supply chain logistics, construction codes, programming standards, balance of assets purchased, or the like). Other measurements of aptitude may be determined based on a user's play of the game such as time to engage, time to design, time to construct, robustness of design, efficiency of spending of virtual currency, or the like).

Thereafter, a determination is made whether to introduce random events (step 507) to create non-linear gamified learning for the level-based competition. The determination to introduce the random event can be made based on the measured aptitude of the user at step 505. The decision may be made based on whether the user has reached a predetermined level of developed industry skills. For example, the decision to introduce the random event at step 507 can be based on whether the user has met or has failed to meet the criteria and/or standards used within the selected industry. Furthermore, the type of random event to be introduced may also be determined at step 507 based on the measured aptitude of the user.

In some embodiments, the type of random event may be simulated at step 517 to test a skill of the user that is at a level above the aptitude measured at step 505. In such an event, an assessment is optionally made by the system at step 519 of a performance and/or response of the user to the random event. This assessment, if optionally made, can be used to determine a score, a ranking and/or a leveling for the user within the game. In some embodiments, the type of random event may be introduced to re-test and/or re-enforce an industry skill of the user that is determined to be a deficiency at step 505. In such an event, the performance and/or response of the user to the random event may be used by the system to determine competency of the user to meet a criteria and/or a standard skill used within the selected industry.

Under a condition that the random event is not to be introduced, a determination is made as to whether a user wins or loses the competition (step 509). In some embodiments, the determination at step 509 may be based on the measured aptitudes at step 505 and/or the assessments optionally made at step 519. In embodiments that involve single player competition levels, the determination at step 509 may be made based on the user's measured aptitude compared to a predetermined industry standard and/or a median score associated with an aggregate of user scores of users who have completed the competition level. In embodiments that involve player vs player competition levels, the determination at step 509 may be made based on a comparison of the players scores during the competition level. In such embodiments, players may be matched based on previously measured aptitudes of the players.

The gaming sequence 500 may further include updating the leveling of players (step 511). The leveling update of the player may be performed based on the measured aptitude at step 505 and/or the win/lose determination at step 509. The leveling update may also be based on an assessment of a user's response (step 519) to one or more random events introduced during the competition level. In some embodiments, the leveling update may be based on a user's aptitude meeting and/or exceeding a standard for an industry skill.

The gaming sequence 500 may also include updating player rankings (step 513). In some embodiments, the player rankings may be updated based on the outcome of the win/lose determination at step 509. The player rankings may also be updated based on the measured aptitudes and/or scoring of an optional assessment of a user's response to a random event at step 519.

At step 515, the current competition ends. New rankings and leveling of the players may be used for future level-based competitions (501) according to some embodiments. Matching of players in a player vs player competition, for example, may be performed based on the updated rankings of the players at step 513. In such embodiments, a new competition may begin at step 501 between the newly matched players in a game mode (e.g., in a tournament play mode). In addition, the leaderboard 300 may be updated at step 513 based on the updated ranking of the players.

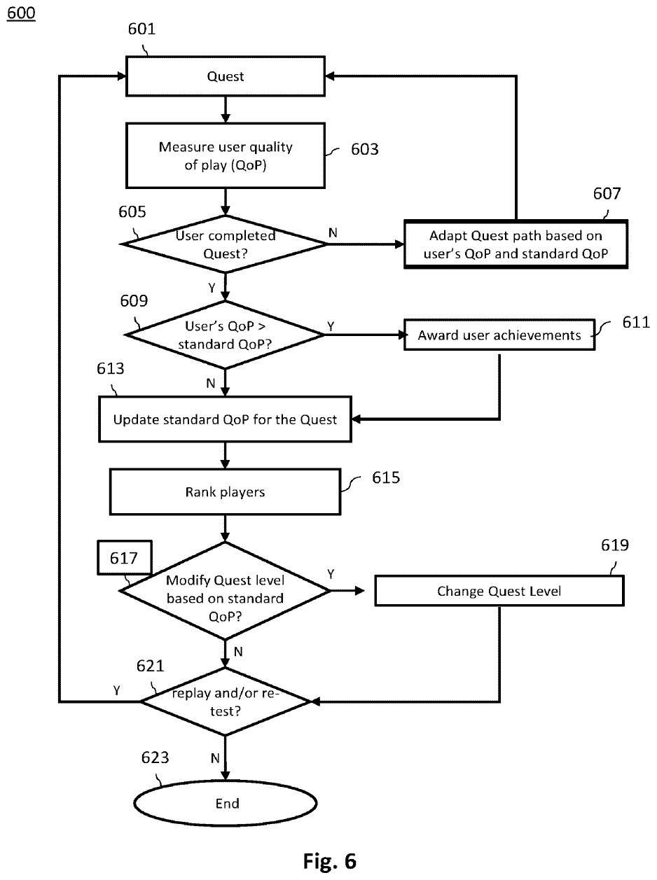

FIG. 6 is a flow diagram of a gamified learning environment 600 to provide training for a user according to yet another embodiment. The gamified learning environment 600 comprises: beginning a quest (step 601); measuring a user's quality of play (QoP) (step 603); and determining that the user has completed the quest (step 605). Under a condition that the user has not completed the quest, the gamified learning environment 600 adapts the quest path based on the user's QoP and a standard QoP (step 607). In some embodiments, the standard QoP may be a pre-determined standard for QoP. In some embodiments, the standard QoP may be determined based on other players' QoP that have previously completed the quest. Under a condition that the user has completed the quest, the gamified learning environment 600 compares the user's QoP to the standard QoP (step 609). If the user's QoP is greater than or equal the standard QoP, the user is awarded achievements (step 611). According to some embodiments, after the comparison (step 609), the standard QoP for the quest is updated based on the user's QoP (step 613). The gamified learning environment 600 further comprises a ranking of players (step 615). Once ranked, a leaderboard may be generated from the ranking of players (step 615) and displayed to the users. According to some embodiments, the gamified learning environment 600 further comprises determining, based on the standard QoP for the quest, whether a difficulty level of the quest should be modified (step 617). If it is determined that the difficulty level of the quest level should be modified, the quest level is changed (step 619). If too few users are able to complete the quest according to the standard QoP, the quest level may be increased to a more difficult level so that only users with more experience are presented with the quest. However, if too many users are able to complete the quest according to the standard QoP, the quest level may be decreased to a less difficult level so that users with less experience can be presented with the quest earlier in their training. After determining whether the difficulty level of quest should be modified (step 617), a decision is made whether the user should replay the quest and/or re-test (step 621). If a replay or re-test is required, the quest can be restarted or if a replay or re-test is not required, the quest may end (step 623).

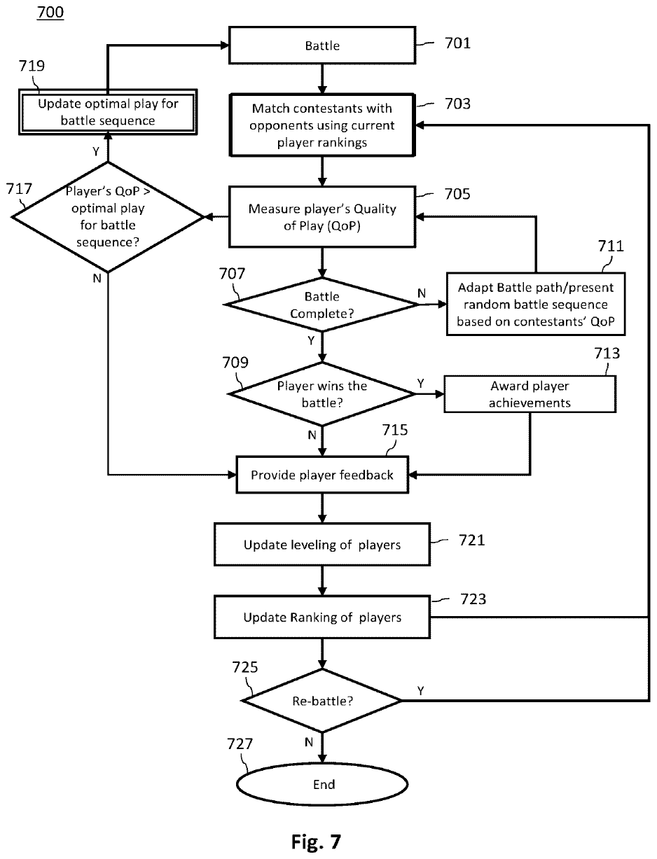

FIG. 7 is a flow chart of a gaming sequence 700 to provide gamified learning for a user to develop expertise according to still another embodiment. The gaming sequence 700 comprises starting a battle (step 701); matching contestants with opponents using current player rankings (step 703); once matched and players begin to battle, the players' quality of play (QoP) is measured during the battle (step 705). The gaming sequence 700 monitors for completion of the battle (step 707) and once complete, a determination is made as to which player won the battle (step 709). If the battle is not complete, an order of battle sequence (e.g., battle path) may be adapted or a random battle sequence may be presented to the contestants (step 711). In some embodiments, the order of the battle sequence and/or the random battle sequence is based on the quality of play of the contestants. Once a winner of the battle is determined, the winner may be awarded achievements (step 713) and the contestants may be provided feedback on their qualify of play (step 715). Based on the measurements of a contestants' quality of play (step 705), comparisons are made between each of the contestants' QoP and an optimal play for the battle sequence (step 717). These comparisons (step 717) may be used to generate some of the feedback provided to the contestants (step 715). If a contestant's quality of play is determined to be greater than the optimal play for the battle sequence (step 717), the optimal play for the battle sequence may be updated (step 719) and used for future comparisons during the battle sequence. Once the battle has been completed (step 707), leveling of the contestants (step 721) and ranking of the contestants (step 723) can be updated. According to some embodiments of the gaming sequence 700, a determination is made as to whether the contestants are to re-battle (step 725) or they are to be matched with other contestants (step 703) and start another battle. Otherwise, the battle for the gaming sequence 700 ends (step 727).

In addition, commercial engagement can allow players to share content with potential employers and certification bodies, enabling a de-facto opportunity for connectivity for both elements. According to some embodiments, measurable aptitude through gaming in combination with the analytics engine used to create the scoring system provide a core value proposition for this system. To be a valued learning and training system tool, the measurable aptitude can be made available to commercial entities to represent skill level. The system can provide access to scoring results and accomplishments of users willing to share outcomes and allow a communication integration. This type of engagement can be modeled to be similar to a college recruitment concept while being far more social/gaming oriented. A commercial entity can interact with the user community to solicit connectivity outside of the system through a messaging protocol and thus facilitate recruitment.

In addition, commercial entities can connect with the user community to solicit opportunities for certification program content as well as testing. Connecting gaming accomplishment and aptitude with commercial certification without geographical boundaries increases the opportunity to allow for exchange of skill for hire. Examples include allowing the user community to exchange achievements for commercial training content or testing credits. The ability to reduce the cost barriers of entry into high demand fields provides a new pool of talent to fields currently struggling to find talent, making a lower barrier to entry to learn skills for certification. The gaming environment thus provides a more universally available and immersive learning method that enables engagement and development of talent based solely on the merit of accomplishment versus access or status.

Connecting with traditional learning and well-known achievement measurements such as vendor certifications can be important connectors in the game. By encouraging the use of available tools to gain knowledge as an extension of play, the user is motivated to participate in less engaging, but valued learning tools. These tools can add skills to game play creating desire and using the opportunity to further create commercial value through recognized certifications which will also add to a user's value in the game.

As described above, machine learning approaches, such as through use of an artificial intelligence engine, include several algorithms to achieve adaptive and measurable learning based on multi-user play. As the gaming environment continues to grow with more users and the data repository becomes more substantial, the evolution of the use of more advanced reinforcement-based algorithms can be added. These algorithms can be used to predict the quality of talent in the user pool to present to prospective employers.

The use of these algorithms can improve substantially the quality of education and the measurable aptitude. This approach can be characterized by the various input sources to the machine learning such as time to complete exercises, adaptive pathways in degree of difficulty of the questions, as well as improvements in scoring over time. For example, a player/student skill level can be based on a combination of the quality of play as well as the degree of effort put into improvement. The measure of effort in traditional learning is difficult to identify and capture, whereas in game play both time of play and effort combined with improvement can be captured. To improve the algorithms overall, the self-learning can use crowd-sourced information gathered from play to continuously measure aptitude. For example, if there are ten total players in the system versus 1000 players in the system, the degree of measure and quality are different.

The style of play and the games can also be “stacked,” such that if a sequence of play is determined to be more complicated, that sequence can be captured as a learning measure and stored in the algorithms. In the same way that tests can be less or more difficult, the stack of play can be identified as a sequence, and various game play models can be used and developed over time to create difficulty measures. For example, within a strategic card playing game a random event generator dubbed the “wheel of unfortunate events” can be used to introduce unpredicted external factors on gameplay. A card can be delivered to play that represents an event or action, and the reaction to that event or action by users can be measured. Depending on the hand of cards a user holds and the event, the reaction possibilities are both measurable, while the permutations and combinations are substantial. Over time the combinations can dictate aptitude and the sequence of events, while random, can be stored in the algorithm for aptitude measurement.

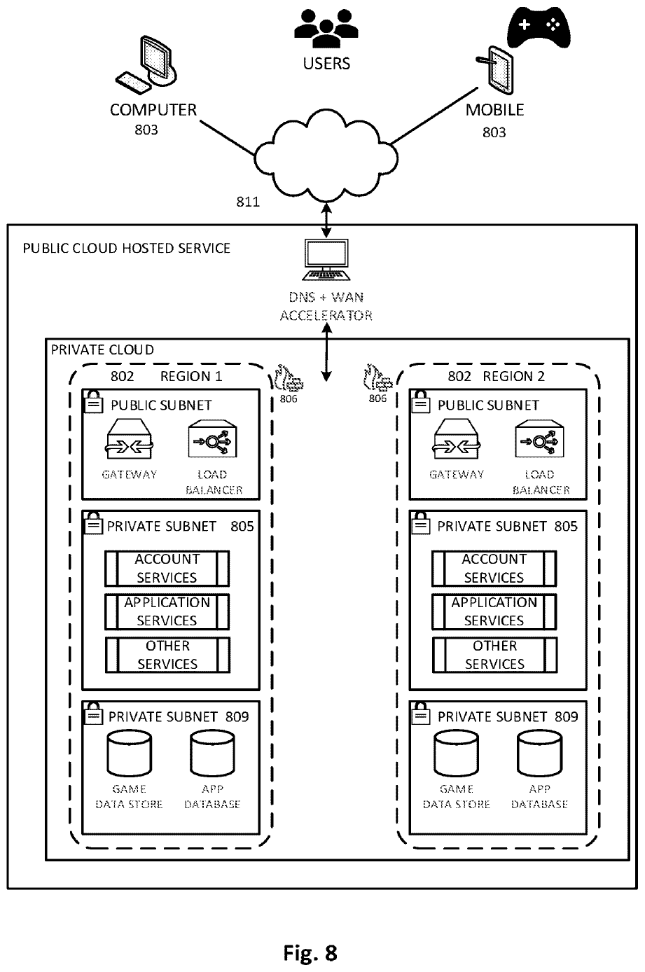

FIG. 8 is a block diagram of network 800 for hosting a gaming environment according to an embodiment. As shown in FIG. 8, the network 800 for hosting the gaming environment using cloud computing services. The user or player would access the gaming environment through a computer or mobile device 803. Upon loading the gaming application on 803 users will connect to the gaming infrastructure 801 communicating through the internet using a network interface protocol (e.g., TCP/IP) 811. The gaming infrastructure 801 is hosted using public cloud infrastructure that connects to multiple private cloud instances 802 through firewalls 806 for redundancy and gaming performance located in multiple geographic regions. The firewalls 806 route and filter traffic securely from the public internet to the private gaming environment. These virtualized data centers 802 are capable of running various application services 805 that operate the gaming environment. These services include user account services, gameplay application services, and many other services for example matchmaking, artificial intelligence, or other machine learning engines.

The application 805 for implementing the gaming environment can be configured to provide all of the functionality of the gaming environment as discussed above. The application services 805 are configured to use elastic load balancing of compute and storage within a region or potentially across regions using the private and public subnets to provide a high performing gameplay experience to the users. These application services 805 store data temporally and permanently using the database layer 809 in a separate private subnet. The database layer 809 will leverage both relational and NoSQL databases to store data in high performance ways to provide a stateful gaming experience and store the critical data over time for users and to manage the gaming environment.

Application 805 can also be configured to include the functionality for implementing a machine learning engine, such as an artificial intelligence engine, to use all of the tracked data from use of the gaming environment 809 to change and improve, for example, the gaming sequences provided to users, the scoring of gaming sequences completed by users, and the criteria for evaluating the quality of responses to actions and events in gaming sequences. The application 805 may be implemented in a distributed configuration (e.g., cloud computing) with different parts of the application 805 being hosted on several servers 801. To facilitate this functionality in application 805, servers 802 can also include a database 809 to collect and store all of the data relevant to the gaming environment and provided by the users including, for example, user registration information, gaming sequences, criteria for evaluating the quality of responses during gaming sequences, scoring algorithms for gaming sequences, responses by users during gaming sequences, and any other data relevant to operating and improving the operation of the gaming environment.

User computer 803 can be a smartphone, mobile phone, tablet, laptop, PC, or other computing device capable of communicating with other devices and running applications. User computer 803 includes processing circuitry that can include circuitry, such as a microprocessor, microcontroller, CPU, memory, RAM, and/or ROM, that can be configured to control all of the operations of server 801. User computer 803 can be configured to control the sending and receiving of data and signals including over a network interface 811 to the Internet, through WiFi, and/or through cellular communication, and run one or more applications including application 805. User computer 803 can send and receive data from server 801 using, for example, WiFi or cellular communication.

Application 805 can be configured to control user computer 803 to send and receive data to and from server 801. Application 805 can also be configured to operate as the interface to the gaming environment to enable users to, for example, receive training information, initiate gaming sequences, display events and actions of gaming sequences, provide responses to actions and events during gaming sequences, display leaderboards, and display relevant user information including levels achieved in the gaming environment.

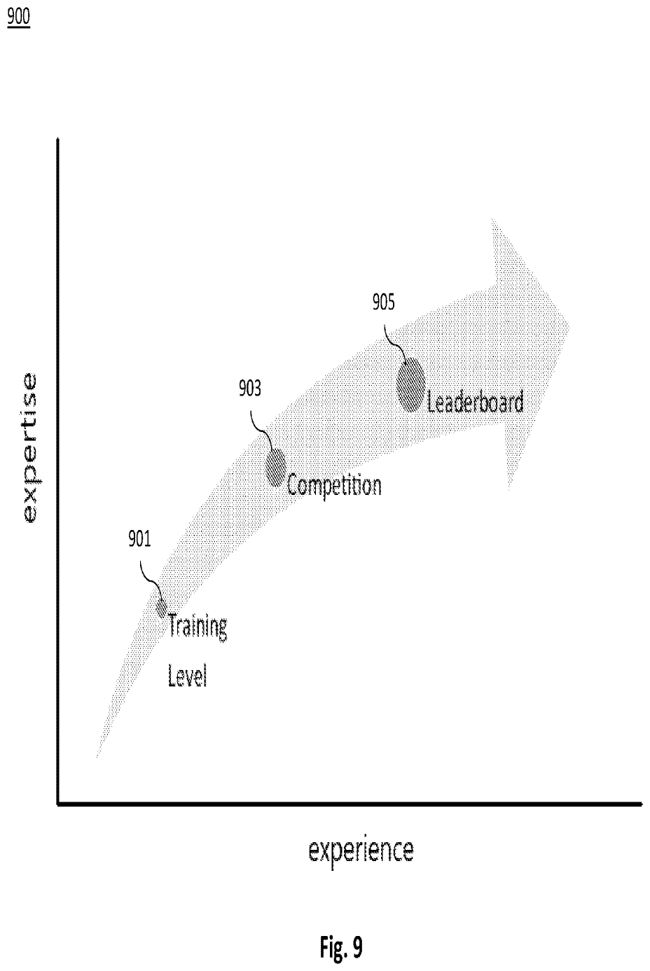

FIG. 9 is a graph 900 illustrating correlations between user experience and user expertise according to some embodiments. In general, the graph 900 depicts user expertise increasing as user experience increases. Graph 900 further illustrates a progression of expertise through different phases of user experience. For example, a user progresses from a training level 901 to a competition phase 903, and eventually to a leaderboard phase 905.

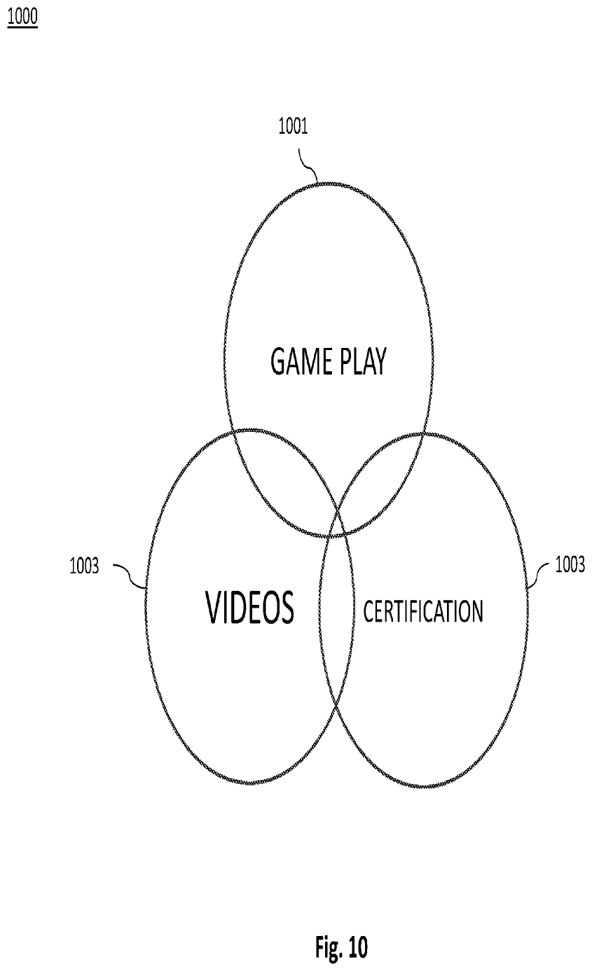

FIG. 10 is a Venn diagram 1000 displaying relationships between game play 1001, videos 1003, and certification 1005 for the gaming environment according to an embodiment. In particular, the Venn diagram 1000 illustrates areas of overlap between game play 1001 and videos, overlap between game play 1001 and certification, overlap between videos 1003 and certification 1003, and overlap between all three. At the center of the Venn diagram 1000 is the user's optimal learning experience. These overlaps allow for a robust training and certification process for the gaming environment.

Various embodiments of the invention are contemplated in addition to those disclosed herein above. The above-described embodiments should be considered as examples of the present invention, rather than as limiting the scope of the invention. In addition to the foregoing embodiments of the invention, review of the detailed description and accompanying drawings will show that there are other embodiments of the present invention. Accordingly, many combinations, permutations, variations, and modifications of the foregoing embodiments of the present invention not set forth explicitly herein will nevertheless fall within the scope of the present invention.

1. A system configured to provide learning through a gaming environment, comprising:
a memory storing a plurality of instructions for executing a gaming environment; and
circuitry coupled to the memory and configured to execute the instructions stored in the memory, execution of the instructions causing the circuitry to:
receive registration information of a first user, the registration information including a unique identifier for the first user;
provide instructional material to the first user, the instructional material including information for building structures and applying tools within the gaming environment;
initiate a first gaming sequence in the gaming environment comprising a series of predetermined actions;
in response to the initiation of the first gaming sequence, receive a first response from the first user, wherein the first response includes at least one of a structure or a tool included in the instructional material for responding to a first action in the first gaming sequence;
measure a quality of the first response against one or more criteria for responding to the first action;
insert a random action into the series of predetermined actions depending on at least one of the measured quality of the first response;
receive a second response from the first user when the random action has been inserted, wherein the second response includes at least one of a structure or a tool for responding to the random action in the first gaming sequence;
measure a quality of the second response against one or more criteria for responding to the random action;
generate a score for the first user based on the quality of responses to the actions in the first gaming sequence;
compare the score for the first user to a first level threshold; and
determine the first user has achieved a first level in proficiency when the score exceeds the first level threshold.

2. The system of claim 1, the memory further comprising an instruction executed by the circuitry to:
generate a score for each of a plurality of other users based on the quality of responses to each of the actions in the first gaming sequence by each of the plurality of other users; and
display a ranking of the first user relative to the plurality of other users based on the respective generated scores.

3. The system of claim 1, the memory further comprising an instruction executed by the circuitry to:
track responses to each of the actions in the first gaming sequence by the first user and a plurality of other users;
provide the tracked responses to a machine learning engine, the machine learning engine maintaining existing information regarding the first gaming sequence including the predetermine series of actions in the first gaming sequence, criteria for responding to the actions in the first gaming sequence, and prior responses of users to actions in the first gaming sequence.

4. The system of claim 1, wherein measuring the quality of the first response comprises measuring a time for the first response to be completed.

5. The system of claim 1, wherein measuring the quality of the first response comprises comparing a sequence of steps used in the first response to a predetermined optimal sequence of steps.

6. The system of claim 1, wherein the predetermined optimal sequence of steps is based a response of another user to the first action.

7. The system of claim 1, wherein the first action is an attack on a network's security and the response is a defense against the attack.

8. A method to provide learning of an industry skill set through a gaming environment, the method comprising:
providing training to a first user for applying the industry skill set within the gaming environment;
initiating a first gaming sequence in the gaming environment comprising a series of predetermined actions related to the industry skill set;
receiving a first response from the first user to an action of the series of predetermined actions;
measuring a quality of the first response against a predetermined optimal response for applying the industry skill set to the action of the series of predetermined actions;
adding a random action into the series of predetermined actions based on the measured quality of the first response;
receive a second response from the first user to the random action;
measure a quality of the second response against a predetermined optimal response for applying the industry skill set to the random action;
determining a level of aptitude of the industry skill set for the first user based on the quality of responses to the first action and the random action in the first gaming sequence;
compare the level of aptitude of the industry skill set for the first user to a first level threshold; and
determine the first user has achieved a first level of aptitude for the industry skill set when the level of aptitude of the industry skill set for the first user exceeds the first level threshold.

9. The method of claim 8 further comprises awarding the first user an industry standard certification associated with the industry skill set in response to the first user achieving the first level of aptitude.

10. The method of claim 8 further comprises:
generating a level of aptitude of the industry skill for each of a plurality of other users based on the quality of responses to each of the actions in the first gaming sequence by each of the plurality of other users; and
generating a ranking of the first user relative to the plurality of other users based on the respective levels of aptitude of the industry skill.

11. The method of claim 10, further comprises:
updating a standard quality of play for the first gaming sequence based on a comparison of the first user's quality of play for the first gaming sequence.

12. The method of claim 11, further comprises:
modifying a level for the first gaming sequence based on the standard quality of play.

13. The method of claim 8 further comprises:
matching a first user with another user based on a player ranking;
conducting a battle based on the first gaming sequence between the first user and the other user; and
updating the player ranking of the first user and the other user based on the outcome of a battle.

14. The method of claim 13, wherein the battle is a competition level game for building a secure network.

15. The method of claim 14, wherein the competition level game includes strategies for securing a network and defending the network from attacks.

16. The method of claim 15, wherein the competition level game is a player versus player style game.

17. The method of claim 15, wherein the competition level game is a team versus team style game and the first user belongs to a first team and the other user belongs to another team.

18. A method to provide learning through a gaming environment, the method comprising:
providing training to a plurality of users for building structures or applying tools within the gaming environment;
measuring aptitudes of the plurality of users for a quest using a predetermined standard level aptitude;
adapting respective quest paths for each user based on respective measured aptitudes of the plurality of users;
matching opponents from the plurality of users based on the measured aptitude levels of the opponents;
initiating a battle sequence in the gaming environment between a first opponent and a second opponent;
measuring a quality of play of the first opponent and the second opponent during the battle sequence against a predetermined optimal quality of play;
modify the predetermined optimal quality of play based on the quality play of the first opponent or the second opponent exceeding the predetermined optimal quality of play; and
using the modified optimal quality of play as the predetermined optimal quality of play for measuring quality of play of other matched opponents.

19. The method of claim 18 further comprising updating a level or ranking of at least one of the first opponent and the second opponent based on the outcome of the battle.

20. The method of claim 19 further comprises matching the first opponent with the second opponent for a re-battle based on the updated level or updated ranking of the at least one of the first opponent and the second opponent.
